(19) United States
(12) Patent Application Publication
(10) Pub. No.: US 2023/0023051 A1
(43) Pub. Date: Jan. 26, 2023

(54) Acetal (POM) Water Valve

(71) Applicants: Ken Bergbauer, Itasca, IL (US); Paul Berkley, Itasca, IL (US); James Eugene Pearson, Itasca, IL (US)

(72) Inventors: Ken Bergbauer, Itasca, IL (US); Paul Berkley, Itasca, IL (US); James Eugene Pearson, Itasca, IL (US)

(21) Appl. No.: 17/725,986

(22) Filed: Apr. 21, 2022

Related U.S. Application Data
(60) Provisional application No. 63/225,751, filed on Jul. 26, 2021.

(51) Int. Cl. F16K 31/40; F16K 27/02

(52) U.S. Cl. CPC F16K 31/404; F16K 27/02

(57) ABSTRACT

An acetal co-polymer valve body and/or spin ring in a solenoid operated dishwasher or washing machine valve has been found to reduce a likelihood of breaking when subjected to freezing and thawing conditions over the polypropylene and glass filled nylon components normally employed in the marketplace.

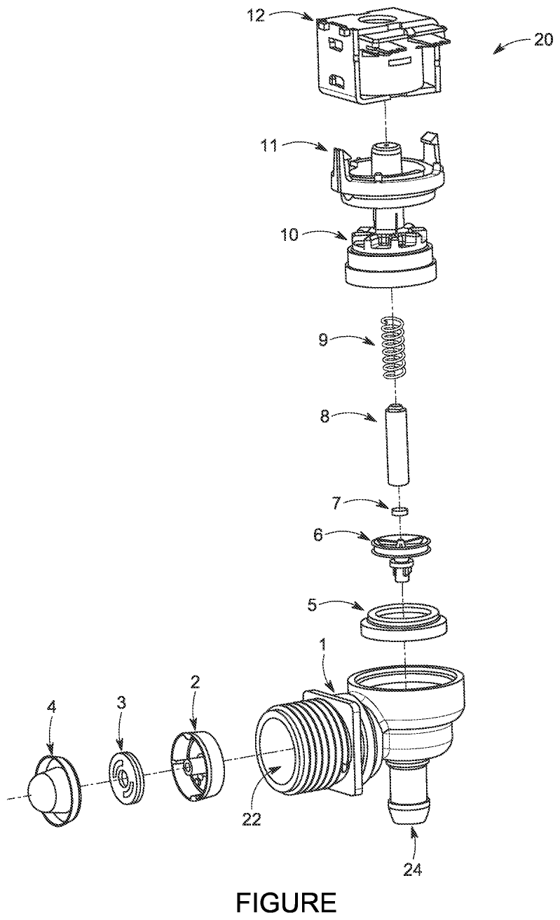

### CLAIM OF PRIORITY

This application claims the benefit of U.S. Provisional Patent Application No. 63/225,571 filed Jul. 26, 2021, which is incorporated herein by reference in its entirety.

### FIELD OF THE INVENTION

The present invention relates to acetal water (Polyoxymethylene, POM) valves such as those utilized in dishwashers and washing machines.

### BACKGROUND OF THE INVENTION

A majority of water valves bodies and spin rings such as those utilized with dishwashers and washing machines for clothes, are presently made of polypropylene, or glass-filled nylon. Polypropylene has many desirable characteristics including a low cost, easy molding capabilities, low molding tool wear and being fairly dimensionally stable. Unfortunately, polypropylene becomes brittle and fractures in extremely low temperatures. While dishwashers and washing machines are normally indoors and maintained above 50° F., if the heater in a residence is turned off (either voluntarily or involuntarily such as by a power outage), frozen pipes often exert pressure on valves which can create a broken valve and thereby expose a manufacturer to potential liability from leakage. Also frozen pipes in vacation homes where the homeowner is gone during a surprise freeze, and southern states where some have appliances in non-heated areas of the home.

Polypropylene has a glass transition temperature (T_{g}) in a range of 0° Celsius to −5° Celsius, which below this, the material and thus the valve and its components made of polypropylene become brittle.

Glass filled (GF) nylon is often utilized for valves that must meet IEC requirements for Europe so that they can pass a high temperature, high pressure, long term stress test. Glass-filled nylon material is typically expensive compared to other materials. Furthermore, the glass-filled content can cause higher mold tool wear particularly as compared to polypropylene. The transition temperature (T_{g}) is high at 50-60° Celsius and glass filled nylon is not particularly ductile. Due to stiffness, glass filled nylon does not fare well with freeze testing.

In the water valve market, particularly for dishwasher and washing machine valves, some customers have institute their own freeze tests, with one company having a particularly stringent test. Ten repeated cycles consisting of 20.5 hours at −30° Celsius and then heated up to 20° Celsius and maintained for 2½ hours with a half hour transition between each cycle. This test requires forty pound per square inch (psi) water pressure maintained throughout the valve accompanied by plugged hoses on the outlets. Standard washing machine hoses are placed on the inlets with isolation valves. A pressure of 40 PSI is applied to the valve, all air is bled out and then the isolation valves are closed. Accordingly, the valves are full of water and under pressure so that when the water freezes it expands, generally 8-10% volumetrically. Larger volumes of water can expand more dimensionally than smaller volumes of water. In order not to break, the plastic will need to contain this expansion at least somewhat and also flex somewhat. The repeated cycles repeatedly flex and stress the body.

In polypropylene and glass-filled nylon valves, this repeated flexing cycle typically causes breakage as the plastic can only handle limited flexing and expansion before breaking. The applicant has discovered the polypropylene materials are brittle at the −30° Celsius temperature which is well below the glass transition temperature (T_{g}). Traditional design efforts such as thickening walls and adding radii inside and outside still failed to provide a satisfactory valve which could survive this test without failure. The polypropylene and glass-filled nylon valves did not make it past four cycles before breaking. Furthermore, the appliance company has space, fitment and flow performance requirements that limit the ability to add material inside and out of the valve.

Accordingly, new water valves are necessary to be able to properly perform satisfactorily for the freezing test of this customer.

### SUMMARY OF THE INVENTION

It is an object of many embodiments of the present invention to be able to provide a water valve to the market that survives repeated cycling between −30° C. and 20° C. This situation could occur in a residence where the heat fails or is not turned on during a cold weather condition and could happen in the northern part of the Unites States of America or elsewhere.

It is another object of many embodiments of the present invention to provide an improved water valve, particularly well adapted to dishwasher and washing machines.

It is another object of many embodiments of the present invention to provide an improved water valve such as for dishwashers and laundry applications which can have at least pressurized housing components made of an acetal co-polymer. This material, while more expensive than polypropylene, is not known to be utilized by the applicant in residential appliances. Acetal co-polymer also has tensile and strength modulus properties higher than polypropylene and also has a glass transition temperature (T_{g}) of minus 50° C. to minus 80° C. before it becomes brittle.

Accordingly, some valves having acetal co-polymer spin rings and valve bodies can pass the freeze test imposed by at least one residential appliance manufacturer. The melt flow is typically higher than polypropylene, so acetal material fills in small details much better.

Acetal co-polymer is denser than polypropylene and the price is usually higher. Although the cost is higher, the performance is believed to be worth the additional cost. Due to the cost requirement and other issues, it is believed that no other manufacturers have attempted to utilize the product in such applications. In testing, the acetal co-polymer produced valves have not been brittle at negative 30° C. and have survived the testing requirements imposed by the appliance manufacturer. With a glass transition temperature (T_{g}) the valve of minus 50° C. or lower, the Acetal valves have still provided respectable flexural modulus and tensile strength to handle the freeze expansion allow them being able to recover when the water is unfrozen. This material has also been able to demonstrate the repeated flexing over repeated cycles. In fact, over two times as many cycles as required by the testing have been able to be performed with these valves.

The acetal co-polymer components perform well when other requirements are factored in, such as spin welding, sonic welder, repetitive accurate molding, and extremely low mold wear as manufacturing dictates. Components such as the valve housing components and possibly internal components subject to pressure whether tensile, tension or compression forces, may be manufactured out of the acetal rather than as formerly made of the polypropylene or glass-filled nylon.

### BRIEF DESCRIPTION OF THE DRAWINGS

The FIGURE is an exploded view of a water valve such as commonly utilized in a dishwasher or washing machine.

### DETAILED DESCRIPTION OF THE PREFERRED EMBODIMENT

The FIGURE shows an exploded view of a water valve 20 which can be a dishwasher valve or a washing machine valve. Often washing machine valves have pairs of valves connected together to receive hot and cold water inlets. Dishwashers typically have a single water inlet. While there are many parts in a valve 20 normally there is a coil assembly 12 housing a solenoid configured to operate on an armature 8 which moves relative to a guide tube 10 to move an armature tip 7 and diaphragm insert 6 up and down so as to selectively seal against diaphragm 5. The armature 8 may be spring biased such as with spring 9 so that the valve 20 fails in a shut or off configuration and/or shuts when the voltage is not high enough to hold the armature 8 (and through the valve 20) in the open position. The diaphragm 5 may be set within a valve body 1 having an inlet 22 and an outlet 24. The inlet 22 may be equipped with a screen 4, a flow washer 3, a flow regulator 2 and/or other components.

While prior art designs have manufactured the water housing, or valve body 1, the solenoid housing, the spin ring 11, and possibly other components out of polypropylene or glass filled nylon, such components have a tendency to become brittle after repeated flexing when subjected to freezing temperatures and after thawing out either during the freezing step or when thawing. Accordingly, the applicant is providing the valve body 1 and spin ring 11 as acetal co-polymer components which is not believed to have ever been done before with residential appliances, particularly for dishwashers and washing machines. Other embodiments of valves 20 may have different constructions but those components containing water (which may freeze or have increased pressure due to freezing) may be acetal copolymer.

Acetal co-polymer would not normally be the first material which comes to mind to replace polypropylene or glass filled nylon. Acetal is subject to UV degradation and can be sensitive to non-uniform part geometry as it may have excess of shrink, warp and voids. Acetal can also be flammable at a high temperature and be difficult to bond. Normal moldings can endure hot temperatures but defective ones can crack. These disadvantages have apparently led manufacturers to rely on the polypropylene and glass-filled nylon construction for valve bodies and spin rings.

While most dishwashers and washing machines have hot water therein, normally not over 110° F. in washing machines but potentially higher in dishwashers, the water valves providing input water do not normally provide water at temperatures above 120° Fahrenheit. They are also somewhat spaced apart from any higher temperatures that may be experienced other than the normal temperature of hot water which does not normally exceed 120° Fahrenheit in residential applications. For laundry valves the cold water in washing machines would normally be less than 80° Fahrenheit.

Accordingly, one of ordinary skill in the art would not be motivated to use acetal co-polymers as pressured components of the valve because most dishwashers and washing machines are not normally subjected to temperatures below −30° Fahrenheit. Polypropylene and glass-filled nylon components such as for the valve bodies 1 and spin ring 11 or other components subjected to pressure function more than satisfactory at those temperatures.

A problem arises in the cycling between freezing and thawing, for which at least one manufacturer has a rather stringent new test which consistently fails the applicant's polypropylene and glass-filled nylon options currently provided in the market. The acetal co-polymer based water valve body 1 and spin ring 11 have found to operate more than satisfactory when made of acetal co-polymers. In fact, these components, and the valve 20, survived two times the testing requirement cycle number of the applicant's customer's test while none of the applicant's glass-filled nylon or polypropylene components manufactured out of the exact same molds have been able to survive the tests.

Numerous alterations of the structure herein disclosed will present themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having set forth the nature of the invention, what is claimed herein is:

1. A residential appliance valve comprising:
a valve body having an inlet and an outlet;
an armature moving relative to a guide tube, said armature having an armature tip connected to a diaphragm insert which selectively seals against a diaphragm on the valve body to thereby provided a closed configuration preventing flow from the inlet to the outlet; said armature movable to unseat the diaphragm insert from the diaphragm to permit flow through the diaphragm in an open configuration;
wherein the valve body is formed of acetal co-polymer.

2. The residential appliance valve of claim 1 wherein the valve is located within one of a dishwasher and a washing machine.

3. The residential appliance valve of claim 2 further comprising a spin ring connecting the guide tube to the valve body.

4. The residential appliance valve of claim 3 wherein the spin ring is formed of acetal co-polymer.

5. The residential appliance valve of claim 1 wherein the armature is spring biased with a spring.

6. The residential appliance valve of claim 5 wherein the valve fails shut upon failure to receive sufficient voltage to maintain the armature and valve in an open configuration.

7. A residential appliance valve comprising:
a valve body having an inlet and an outlet;
an armature moving relative to a guide tube, said armature having an armature tip connected to a diaphragm insert which selectively seals against a diaphragm on the valve body to thereby provided a closed configuration preventing flow from the inlet to the outlet; said armature movable to unseat the diaphragm insert from the diaphragm to permit flow through the diaphragm in an open configuration;
and a spin ring retaining the guide tube to the valve body;
wherein the spin ring is formed of acetal co-polymer.

8. The residential appliance valve of claim 7 wherein the valve is located within one of a dishwasher and a washing machine.

9. The residential appliance valve of claim 8 wherein the armature is spring biased with a spring.

10. The residential appliance valve of claim 9 wherein the valve fails shut upon failure to receive sufficient voltage to maintain the armature and valve in an open configuration.

11. The residential appliance valve of claim 10 wherein the spin ring is formed of acetal co-polymer.
